(19) United States
(12) Patent Application Publication
(10) Pub. No.: US 2013/0237886 A1
(43) Pub. Date: Sep. 12, 2013

(54) PORTABLE TOOL FOR SELF-DECONGESTING AND REDUCING INFLAMMATION OF THE SPINE

(71) Applicant: Patrizia Maria Rita Gavoni, Lucca (IT)

(72) Inventor: Patrizia Maria Rita Gavoni, Lucca (IT)

(73) Assignee: Patrizia Maria Rita Gavoni, Lucca (IT)

(21) Appl. No.: 13/885,788

(22) PCT Filed: Nov. 16, 2011
(86) PCT No.: PCT/IT2011/000377

§ 371 Date: May 16, 2013

(30) Foreign Application Priority Data
Nov. 17, 2010 (IT) LU2010A000014

(51) Int. Cl. A61H 23/00

(52) U.S. Cl. CPC A61H 23/004
USPC 601/83

(57) ABSTRACT

The invention applies to the sector of devices for therapeutic and physiotherapy use and relates to a portable tool (1) for self-decongesting and reducing inflammation of the rachis of a user including two rods (2, 3) arranged for being placed at the sides of the spine, wherein the tool includes first flexible connecting elements (5) for the two rods (2, 3), arranged for limiting the mutual lateral displacement thereof between two pre-defined positions (D1, D2) of minimum and maximum distance and wherein the first connecting elements (5) are arranged for allowing non-parallel positioning of the two rods (2, 3) in a substantially convergent manner.

The invention applies to the sector of devices for therapeutic and physiotherapy use.

More in detail, the invention relates to a portable tool for self-decongesting and reducing inflammation of the rachis of a user.

This tool can in fact be used in a sporting, physiotherapy and medical field in general to relax the muscle and nerve fasciae at the sides of the spine and therefore the rachis itself.

The rachis is the structure that supports the head and the torso and protects the spinal cord, and occupies a postero-medial position in the human body.

The rachis is formed essentially of vertebrae and joints, called facet joints, of intervertebral discs, and is in connection with intrinsic muscles of the spine.

The peripheral nerves emerge from the rachis as a whole and innervate the viscera, body parts, bones, dermal tissue layers and muscles of our body.

The tool according to the invention in particular acts on the sensitive receptors of the rachis.

States of particular physical fatigue, psycho-emotional stress, postural stress caused by maintaining an inappropriate position at length, physical traumas such as “whiplash”, but also degenerative pathologies such as hernias, etc., are all conditions that can cause inflammation of the rachis and of its muscles.

These inflammations have numerous symptoms: subcontinuous pain, radiation of pain at the base of the occipital bone or in the interscapular-vertebral or pelvic area, varying degrees of limited mobility, crackling sensations and noises, muscle spasms in general, etc . . .

To relieve these inflammations, massages and finger pressure are often required, suitably performed by physiotherapists or specialists in the field, who apply pressure to particular eminences of the vertebral bones, or make the person affected perform movements of rotation or lateroflexion of the painful vertebral segment.

Alternatively, massage of the fascia of the back can also be carried out on the person affected using active or passive gymnastic machines, such as those used to practice Pilates, a discipline to train the body, designed and conceived to develop muscle strength and flexibility, strengthen abdominal muscles, give full control of the body, great flexibility, coordination of the spine and limbs.

Regrettably, massage and finger pressure performed by physiotherapists have relatively high costs, often require appointments and have long waiting times, and oblige the sufferer to travel to physiotherapy centres.

Similarly, the use of specific gymnastic machines requires a gym membership and again obliges the sufferer to travel.

Moreover, gymnastic machines for home use are also inconvenient: they are bulky, complicated to use without the support and help of competent technical operators and, naturally, also costly.

Moreover, these machines do not act simultaneously on the rachis and on the whole of the portion of the back, but on a single area at a time.

A home alternative to the use of these specific machines is the use of more simple instruments, already used in the practice of yoga and postural gymnastics, such as elongated tubular elements, generally made of rubber, which are positioned at the sides of the spine.

The sufferer lies on top of these tubular elements and, associated with conscious breathing, this performs a sort of pressure and massage on the rachis and therefore causes a state of general relaxation of the rachis and of its muscles, with benefit also for the internal organs connected to each single section of the back.

In use, to obtain greater benefit, the user requires a support element to place under the curve of the spine at the level of the cervical vertebrae.

However, even these simple instruments have limits and disadvantages.

The greatest difficulty for the user is that of maintaining this instrument in the correct position during use: their tubular shape tends to cause them to slip and move away from each other, distancing them from the spine even in a disarranged manner, and therefore eliminating the benefit of the massage technique and relaxation.

Even more disadvantageously, to increase comfort during use of the tools, the user is obliged to find an effective, comfortable and suitably shaped support to adapt to the curve of the spine, which however is not always available.

Moreover, these tubular elements are not always practical to carry, and therefore the user is obliged to carry out the massage only at home.

The invention intends to overcome these limits by providing a portable tool for self-decongesting and reducing inflammation of the muscle and nerve fasciae of the rachis which is compact, simple to use and effective for self-medication.

Yet another object of the invention is to make said tool portable and consequently also easy to use outside the home.

These aims are achieved with a portable tool for self-decongesting and reducing inflammation of the rachis of a user comprising two rods arranged for being placed at the sides of the spine, characterized in that it comprises first flexible connecting means for said two rods, arranged for limiting the mutual lateral displacement thereof between two pre-defined positions of minimum and maximum distance.

According to a first embodiment of the invention, said first connecting means are arranged for allowing non-parallel positioning of said two rods in a substantially convergent manner.

In particular, the cross section of said rods comprises at least a flat surface and at least a curved surface.

Advantageously, said rods are coated with elastically yielding material.

In a possible embodiment of the invention, said rods comprise a copper foil arranged underneath said elastically yielding material, at least in the portion that, in use, is in contact with the user.

According to a further embodiment of the invention, said tool comprises a cervical support shaped to adapt to the curve of the spine at the level of the cervical vertebrae and second flexible connecting means directly or indirectly arranged between said cervical support and said rods.

Advantageously, said cervical support comprises at least a body made of elastically yielding material.

In a possible embodiment, said first connecting means comprise a trapezoidal shaped bag arranged for containing said rods, and advantageously said bag comprises a longitudinal median seam and a carrying strap.

Moreover, said second connecting means comprise a pocket associated with said bag arranged for containing said cervical support.

The invention presents numerous advantages.

The first flexible connecting means between said two rods solve the problem for the user of having to personally check that they remain in position at the sides of the spine of the rachis during use of the tool.

Carrying out of said first connecting means by means of a bag makes the tool practical and compact, easy to transport, also thanks to the shoulder strap. Besides the longitudinal seam maintains the rods in the correct position of use, preventing them from rotating or moving too close to each other.

The substantially trapezoidal shape of the bag allows non-parallel positioning of the rods to adapt better to the anatomy of the body. In particular, said arrangement is comprised between a maximum distance defined by the width of said bag and a minimum distance limited by the seam and by the dimension of the spine.

The flexibility of the connecting means allows the user to adjust the tool to treat the fascia of the back that is most affected: in fact, the rods can be moved toward or away from each other at will at the sides of the spine.

The second flexible connecting means always provide the user with a cervical support appropriately shaped and maintained in the most correct manner, which can be positioned according to need for complete and effective treatment.

The cervical support comprises at least a body in elastically yielding material, shaped to adapt to the curve of the spine at the level of the cervical vertebrae, having a releasing function, if positioned in the physiological cervical lordosis, or a function of slight traction and passive elongation of the cervical rachis, if positioned under the occipital bone.

The flat surface of the rods ensures that the tool rests stably on the horizontal surface on which the user is lying, while the curved surface acts on the muscles at the sides of the spine to exert the actual pressures.

The longitudinal seam of the bag limits rotation of the rods and contributes to maintain the rods in position.

The elastically yielding material that covers the rods provides greater comfort for the user, while the copper foil facing the portion of the rod in contact with the body is adapted to absorb its magnetic fields, advantageously releasing tension.

Even more advantageously, the bag shape of the first flexible connecting means and the presence of the carrying strap make the tool portable.

The second flexible connection means allow adjustment and modification of the cervical support of the tool and use of the same tool by persons of different height.

The openable pocket produced in the bag also allows removal of the cervical support and changing of the element or elements of which it is composed with others of different shape and consistency, as well as their use for specific local treatments of the back muscles.

The shape of the tool, and in particular of the elements of which it is composed, therefore ensures, with a few simple movements, a high pressure massage, which is carried out along the whole fascia of the back.

The advantages of the invention will be made clearer below with the description of a preferred embodiment, provided by way of non-limiting example, and with the aid of the drawings wherein:

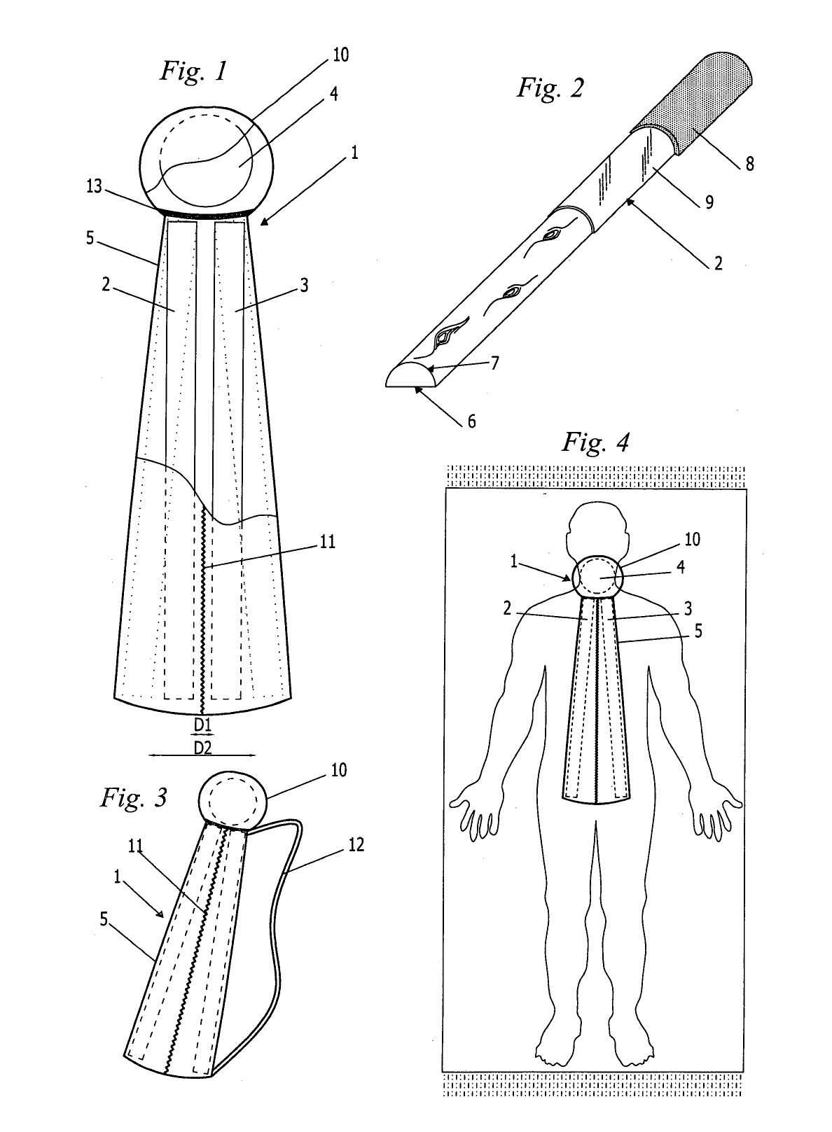

FIG. 1 represents, in a partly sectional top front view, the portable tool for self-decongesting and reducing inflammation of the rachis according to the invention;

FIG. 2 represents, in an axonometric view, an element of the tool of FIG. 1;

FIG. 3 represents, in an axonometric view, the tool of FIG. 1;

FIG. 4 represents, in a top view, the tool of FIG. 1 during use.

With reference to FIG. 1, this shows a portable tool 1 for self-decongesting and reducing inflammation of the rachis.

Said tool 1 comprises two rods 2 and 3, arranged for being placed at the sides of the spine of a user, and a cervical support 4.

Said tool 1 also comprises first flexible connecting means for said two rods 2 and 3.

Said connecting means are arranged for limiting, in use, the mutual lateral displacement of the two rods 2 and 3 between two positions D1 and D2 of minimum and maximum distance.

The position of minimum distance D1 between the rods 2 and 3 is reached when these are arranged adjacent to the spine.

In said position of maximum distance D2 between the rods 2 and 3, said rods are non-parallel with each other, convergent in proximity of the cervix and divergent at the height of the pelvis.

Said connecting means are produced by means of a bag 5 made of washable fabric with a substantially trapezoidal shape.

The bag comprises a longitudinal median seam 11 that divides it into two compartments, each arranged for containing and maintaining in position the rods 2 and 3.

A carrying strap 12 is also associated with said bag.

Said tool 1 comprises second flexible connecting means arranged for connecting said cervical support directly or indirectly to said rods 2 and 3.

Said second connecting means comprise a pocket 10, again made of fabric, associated with said bag and arranged for containing said cervical support 4.

The pocket comprises a Velcro®-type fastener 13, which allows removal and, if necessary, replacement of the cervical support element 4.

Said cervical support 4 comprises a body made of elastically yielding material having a substantially spheroidal shape, for example made of expanded plastic material. Alternatively, it could comprise two spheroidal bodies of smaller diameter. In this latter case, the two spheroidal bodies could in turn be contained in a bag made of fabric or mesh to be maintained together also after being removed from the pocket 10 and thus usable to exert pressure on specific points of the user's body.

With particular reference to FIG. 2, said rods 2 and 3, made of wood, have a substantially semi-circular shape and therefore have a flat surface 6 and at least a curved surface 7.

Said rods 2 and 3 are coated with elastically yielding material 8, for example expanded polyurethane.

Said rods 2 and 3 can also comprise a copper foil 9 arranged underneath said elastically yielding material 8 near the curved surface 7, or at least in the part that, in use, is in contact with the rachis.

Use of the portable tool 1 according to the invention is simple and is described below.

The user positions the tool 1 on a horizontal surface, for example the floor, taking care that the flat surface 6 of the rods 2 and 3 is facing the floor.

Subsequently, the user lies in a supine position on top of the tool 1, so that the rods 2 and 3 are positioned at the sides of the spine and the cervical support 4 fills the curve at the base of the neck or is positioned under the occipital bone.

Once in position, the user moves the rods 2 and 3 toward or away from each other, to find the most beneficial position.

By controlling breathing, relaxing the body, the weight of the user's body cooperates with the rods to exert pressures and consequently carry out a beneficial massage.

The invention, as described and illustrated, allows the preset aims and objects to be achieved.

In practice, it is clear that all details of geometry, shape and dimension can be substituted with other functionally equivalent details, just as the materials can vary according to requirements and to the scope of application, without however departing from the scope of protection of the claims.

1. Portable tool (1) arranged for self-decongesting and reducing inflammation of the rachis of the user comprising two rods (2, 3) arranged for being placed at the sides of the spine, characterized in that it comprises first flexible connecting means (5) for said two rods (2, 3), arranged for limiting the mutual lateral displacement thereof between two pre-defined positions (D1, D2) of minimum and maximum distance.

2. Tool (1) according to claim 1, characterized in that said first connecting means (5) are arranged for allowing non-parallel positioning of said two rods (2, 3) in a substantially convergent manner.

3. Tool (1) according to claim 1, characterized in that the cross section of said rods (2, 3) comprises at least a flat surface (6) and at least a curved surface (7).

4. Tool (1) according to claim 1, characterized in that said rods (2, 3) are coated with elastically yielding material (8).

5. Tool (1) according to claim 4, characterized in that said rods (2, 3) comprise a copper foil (9) arranged underneath said elastically yielding material (8), at least in the portion that, in use, is in contact with the user.

6. Tool (1) according to claim 1, characterized in that it comprises a cervical support (4) shaped to adapt to the curve of the spine at the level of the cervical vertebrae and second flexible connecting means (10) directly or indirectly arranged between said cervical support (4) and said rods (2, 3).

7. Tool (1) according to claim 6, characterized in that said cervical support (4) comprises at least a body made of elastically yielding material.

8. Tool (1) according to claim 1, characterized in that said first connecting means (5) comprise a trapezoidal shaped bag arranged for containing said rods (2, 3).

9. Tool (1) according to claim 8, characterized in that said bag comprises a longitudinal median seam (11) arranged for dividing it into two compartments.

10. Tool (1) according to claim 6, characterized in that said first connecting means (5) comprise a trapezoidal shaped bag arranged for containing said rods (2, 3), and said second connecting means (10) comprise a pocket associated with said bag arranged for containing said cervical support (4), wherein said pocket comprises a Velcro®-type fastener (13).
